(19) United States
(12) Patent Application Publication
(10) Pub. No.: US 2022/0198371 A1
(43) Pub. Date: Jun. 23, 2022

(54) ACTION MANAGEMENT METHOD, PROGRAM, AND ACTION MANAGEMENT SYSTEM

(71) Applicant: Panasonic Intellectual Property Management Co., Ltd., Osaka (JP)

(72) Inventors: Yuka YAMAMOTO, Osaka (JP); Misa YOSHIZAKI, Osaka (JP); Nobuaki YABUNOUCHI, Kyoto (JP); Ryo KAWAMURA, Kanagawa (JP)

(21) Appl. No.: 17/598,850

(22) PCT Filed: Jan. 9, 2020
(86) PCT No.: PCT/JP2020/000420

§ 371 Date: Sep. 27, 2021

(30) Foreign Application Priority Data
Mar. 27, 2019 (JP) 2019-061931

(51) Int. Cl. G06Q 10/06

(52) U.S. Cl. CPC G06Q 10/063116; G06Q 10/06312; G06Q 10/0639

(57) ABSTRACT

An action management method includes generation processing and acquisition processing. The generation processing includes generating a schedule in accordance with an arrangement order of a plurality of action modules. The plurality of action modules represent respective actions to be performed by a target person. The schedule indicates an order in which the target person is supposed to perform the actions. The acquisition processing includes acquiring an action log indicating an execution status in which the target person is following the schedule.

### TECHNICAL FIELD

The present disclosure generally relates to an action management method, a program, and an action management system, and more particularly relates to an action management method, a program, and an action management system, all of which are configured or designed to manage a target person's actions.

### BACKGROUND ART

Patent Literature 1 teaches equipping a kids desk with an audio output device including: a switch attached to a top board; an audio output control unit including a memory in which a series of verbal commands prompting the target person to perform a particular type of action (act); and a loudspeaker. In this kids desk, when the switch is pressed, the audio output control unit sequentially emits the series of verbal commands prompting the target person to perform a particular type of action.

Patent Literature 1 also teaches associating each time range of the day with a series of verbal commands that prompt the person to perform a particular type of action (hereinafter referred to as “prompter verbal commands”) appropriate for that time range and sequentially emitting the series of such prompter verbal commands associated with a time range during which the switch is pressed. In the kids desk with such a configuration, every time a kid presses the switch, the series of verbal commands prompting the kid to perform the particular type of action are sequentially emitted as prompter verbal commands from the audio output device, thus allowing the kid to perform the particular type of action by interacting with the kids desk.

### CITATION LIST

### Patent Literature

Patent Literature 1: JP 2013-287 A

### SUMMARY OF INVENTION

According to the method of Patent Literature 1, the target person (kid) is just prompted to perform a particular type of action, and therefore, it is difficult to evaluate the action that the target person has actually performed in response to the prompter commands.

In view of the foregoing background, it is therefore an object of the present disclosure to provide an action management method, a program, and an action management system, all of which facilitate evaluation of the action that the target person has actually performed.

An action management method according to an aspect of the present disclosure includes generation processing and acquisition processing. The generation processing includes generating a schedule in accordance with an arrangement order of a plurality of action modules. The plurality of action modules represents actions to be performed by a target person. The schedule indicates an order in which the target person is supposed to perform the actions. The acquisition processing includes acquiring an action log indicating an execution status in which the target person is following the schedule.

A program according to another aspect of the present disclosure is designed to cause one or more processors to perform the action management method described above.

An action management system according to still another aspect of the present disclosure includes a generation unit and an acquisition unit. The generation unit generates a schedule indicating an order in which a target person is required to perform actions. The acquisition unit acquires an action log indicating an execution status in which the target person is following the schedule. The generation unit generates the schedule in accordance with an arrangement order of a plurality of action modules representing the respective actions to be performed by the target person.

### BRIEF DESCRIPTION OF DRAWINGS

FIG. 1 is a schematic representation illustrating a general idea of an action management method according to a first embodiment;

FIG. 2 is a schematic representation illustrating a general idea of an action management system according to the first embodiment;

FIG. 3 is a block diagram illustrating a configuration for an action module in the action management system;

FIG. 4A is a schematic perspective view illustrating a configuration for the action module;

FIG. 4B is a schematic perspective view illustrating an example in which a plurality of action modules are arranged side by side;

FIG. 5A is a schematic representation schematically illustrating how a schedule is generated when a plurality of action modules are arranged side by side according to the action management method;

FIG. 5B is a schematic representation schematically illustrating how a schedule is generated when a plurality of action modules are arranged side by side according to the action management method;

FIG. 5C is a schematic representation schematically illustrating how a schedule is generated when a plurality of action modules are arranged side by side according to the action management method;

FIG. 6A is a schematic representation schematically illustrating how an action log is generated in accordance with a target person's operation on the plurality of action modules according to the action management method;

FIG. 6B is a schematic representation schematically illustrating how an action log is generated in accordance with a target person's operation on the plurality of action modules according to the action management method;

FIG. 6C is a schematic representation schematically illustrating how an action log is generated in accordance with a target person's operation on the plurality of action modules according to the action management method;

FIG. 7 is a flowchart showing an exemplary procedure of the action management method; and

FIG. 8 is a schematic representation illustrating a screen image of a telecommunications device that uses the action management method of the first embodiment.

### DESCRIPTION OF EMBODIMENTS

### First Embodiment

### (1) Overview

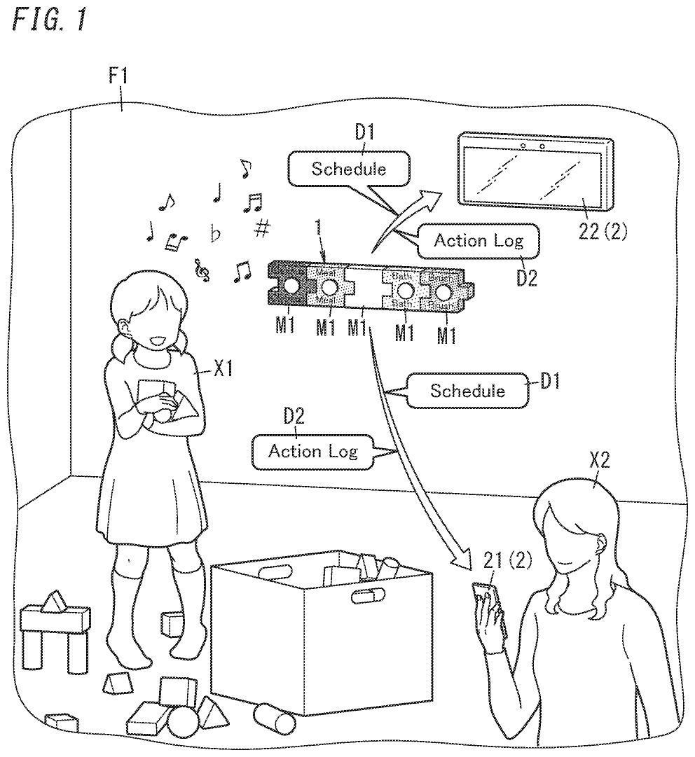

An overview of an action management method according to an exemplary embodiment will be described with reference to FIG. 1.

The action management method is a method for managing a target person's X1 actions. In particular, an action management method according to this embodiment enables the target person's X1 actions to be managed time sequentially by managing the target person's X1 actions using a schedule indicating the order in which the target person X1 is required to perform a plurality of actions.

Such an action management method allows the order in which the target person X1 is supposed to perform, in his or her daily life, various types of actions, such as cleaning up, studying, exercising, taking meals, taking a bath, changing clothes, washing teeth, and sleeping, to be defined by the schedule. Thus, according to this action management method, the actions that the target person X1 needs to perform in his or her daily life, as well as their order, may be managed. For example, if the order in which a plurality of actions (such as taking meals and taking a bath) need to be performed is defined by the schedule such that the target person X1 should take a bath after having taken a meal, then the target person X1 is supposed to take a bath after having taken a meal following the schedule. It is expected that managing the target person's X1 actions in such an organized manner in the form of a schedule would contribute to forming a good habit of following the schedule for the target person X1.

An action management method according to this embodiment includes generation processing and acquisition processing. The generation processing includes generating a schedule D1 in accordance with an arrangement order of a plurality of action modules M1. The plurality of action modules M1 represent respective actions to be performed by the target person X1. The schedule D1 indicates an order in which the target person X1 is supposed to perform the actions. The acquisition processing includes acquiring an action log D2 indicating an execution status in which the target person X1 is following the schedule D1.

According to such an action management method, a schedule D1 is generated through the generation processing in accordance with an arrangement order of a plurality of action modules M1 representing respective actions to be performed by a target person X1. Therefore, even if the target person X1 is going to set his or her own schedule D1 by him- or herself, for example, the target person X1 may generate the schedule D1 relatively easily simply by rearranging the plurality of action modules M1. In addition, according to this aspect, information about an execution status in which target person X1 is following the schedule D1 may be acquired in the form of an action log D2. Therefore, this action management method achieves the advantage of allowing the degree of faithfulness, with which the target person X1 has actually performed the actions following the schedule D1, to be evaluated easily based on the action log D2.

### (2) Details

The action management method according to this embodiment will be described in detail with reference to FIGS. 1-7.

(2.1) Premise

In this embodiment, the action management method is supposed to be carried out in a facility F1 such as a single-family dwelling house or each dwelling unit of a multi-family dwelling house. That is to say, in this embodiment, the action management method is supposed to be applied to managing the actions of the target person X1 in the facility F1 (dwelling facility).

As used herein, the “target person” refers to any person whose actions need to be managed by the action management method. The target person X1 may be a person of any of various age groups, of any gender, or having any disease or disability, for example. Also, the target person X1 may be a particular individual or an unspecified individual or may even be group of multiple persons. In the following description of embodiments, a situation where the target person X1 is a kid whose recognition capabilities are still under development will be described. As used herein, the “kid” refers to a child who is one year old or older and who does not go to school yet (i.e., a pre-school child).

In this embodiment, a family consisting of three persons, namely, a father, a mother, and a child who is the “kid,” for example, is supposed to live in the facility F1 (dwelling facility). In this case, the child is the target person X1 out of the father, mother, and the child who are residents of the facility F1. That is to say, in this embodiment, a particular individual that is the child who lives in the facility F1 is the target person X1 whose actions are managed by the action management method. Also, at least one of the father or mother who lives in the facility F1 is a manager X2 who manages the target person's X1 actions by using the action management method. In this embodiment, the mother is supposed to be the manager X2, as an example.

As used herein, the “action” refers to an action to be performed by the target person X1. Examples of actions include various types of actions such as cleaning up, studying, exercising, taking meals, taking a bath, changing clothes, washing teeth, and sleeping. In this case, the types of the actions to be managed by the action management method vary according to the target person X1. For example, if the target person X1 is a kid, then actions for kids to perform, such as playing with a building blocks construction set, playing with toys, drawing, and taking lessons in singing a song, are managed by the action management method. On the other hand, if the target person X1 is an adult (such as the mother), then actions for adults to perform, such as cleaning, laundering, and cooking, are managed by the action management method. Optionally, a single action may be subdivided into two or more actions. For example, the single action “exercising” may be subdivided into two actions of “rhythm exercises” and “stretching.” Furthermore, the beginning and end of a single action may be defined as two different actions. For example, as for the single action “sleeping,” two different actions of “going to bed” as the beginning of “sleeping” and “getting up” as the end of “sleeping” may be defined.

As used herein, the “action module” refers to a functional unit corresponding one to one to the target person's X1 action and may be either a tangible object or an intangible object, whichever is appropriate. That is to say, the “action module M1” may be a tangible block such as a puzzle block or one of the blocks that form a building blocks construction set. Alternatively, the “action module” may also be an intangible block such as an icon displayed on a screen. In this embodiment, the action module M1 is supposed to be a tangible object as an example.

As used herein, the “arrangement order” refers, on the supposition that the plurality of action modules M1 are arranged side by side, to the order in which the action modules M1 are arranged. For example, if the plurality of action modules M1 are coupled together to be arranged in line, then the order in which the plurality of action modules M1 are arranged with one end of the line regarded as a top defines the arrangement order of the plurality of action modules M1. Also, even if the plurality of action modules M1 are not coupled together, the arrangement order of the plurality of action modules M1 may also be defined. For example, if the plurality of action modules M1 are arranged on a single virtual line (or a curve), then the order in which the plurality of action modules M1 are arranged with one end of the virtual line regarded as a top defines the arrangement order of the plurality of action modules M1.

As used herein, the “execution status” refers to a current status in which the target person X1 is performing the plurality of actions defined by the schedule D1 in terms of which of the plurality of actions the target person X1 is now performing or has performed. For example, if the target person X1 is now performing the first one of the plurality of actions, of which the order is defined by the schedule D1, then the execution status of the schedule D1 indicates that the target person X1 is now performing the first action. For example, if the schedule D1 defines the order in which cleaning up, taking meals, taking a bath, and washing teeth are supposed to be performed is defined by the schedule D1 and the target person X1 is now taking a bath, then the execution status of the schedule D1 indicates that the target person X1 is now taking a bath as the third action.

(2.2) Configuration for Action Management System

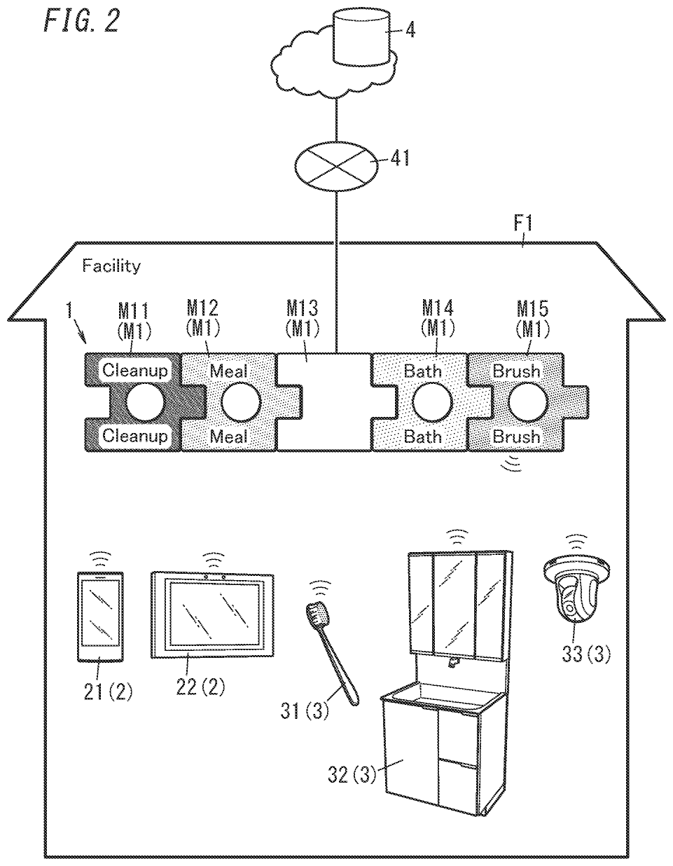

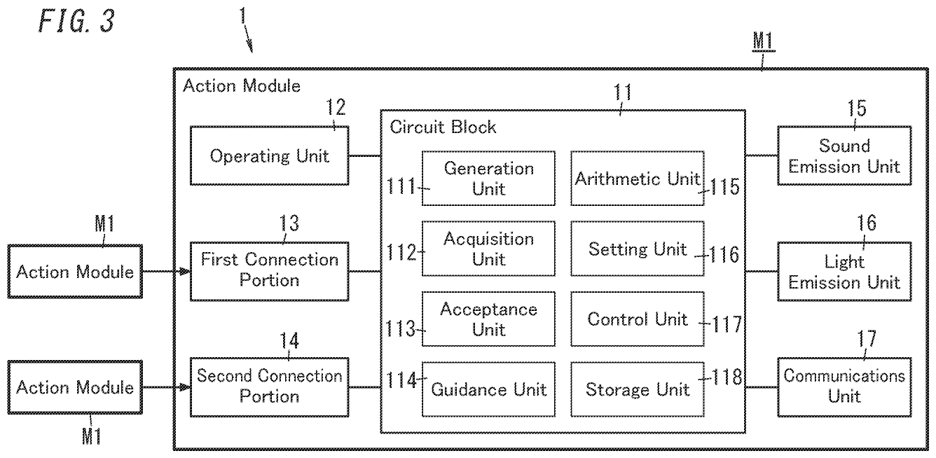

Next, a configuration for an action management system 1 according to this embodiment will be described with reference to FIGS. 2 and 3.

The action management method according to this embodiment is carried out by the action management system 1. In other words, the action management system 1 according to this embodiment is a system for carrying out the action management method.

The action management system 1 includes a generation unit 111 (see FIG. 3) and an acquisition unit 112 (see FIG. 3). The generation unit 111 generates a schedule D1 indicating an order in which a target person X1 is required to perform actions. The acquisition unit 112 acquires an action log D2 indicating an execution status in which the target person X1 is following the schedule D1. The generation unit 111 generates the schedule D1 in accordance with an arrangement order of a plurality of action modules M1 representing the respective actions to be performed by the target person X1. That is to say, the generation processing of the action management method is performed by the generation unit 111. In addition, the acquisition processing of the action management method is performed by the acquisition unit 112.

In this embodiment, the action management system 1 is implemented as at least one action module M1. In the example illustrated in FIG. 2, the action management system 1 is implemented as a plurality of (e.g., five in the example illustrated in FIG. 2) action modules M11-M15 which are combined together. In the following description, when there is no need to distinguish the plurality of action modules M11-M15 from each other, the plurality of action modules M11-M15 will be hereinafter collectively referred to as “action modules M1.”

The functions of the generation unit 111 and acquisition unit 112 of the action management system 1 are provided for each action module M1 as shown in FIG. 3. Each action module M1 may operate even by itself. Therefore, even a single action module M1 may form the action management system 1. On the other hand, if a plurality of action modules M1 are combined together as shown in FIG. 2, a single action management system 1 is formed by these action modules M1.

In this embodiment, when the plurality of action modules M1 are combined together, any one of the plurality of action modules M1 functions as a master device. Meanwhile, the rest of the plurality of action modules M1 other than the action module functioning as the master device serve as slave devices. It is defined by a master device setting condition which of the plurality of action modules M1 functions as the master device. In this embodiment, for example, an action module M1, of which a first connection portion 13 is connected for the first time to another action module M1 among the plurality of action modules M1 in a state where there is no master device among the plurality of action modules M1 combined together, is defined to be the master device.

In this embodiment, the action management system 1 is configured to be ready to communicate with each of telecommunications devices 21, 22, devices 31, 32, 33, and a cloud computing system 4 as shown in FIG. 2. As used herein, if some device is “ready to communicate” with another device, this means that these two devices are ready to exchange signals either directly or indirectly via a network 41 or a relay, for example, by an appropriate communication method such as wired communication or wireless communication. That is to say, the action management system 1 may exchange signals between the plurality of telecommunications devices 21, 22, the plurality of devices 31, 32, 33, and the cloud computing system 4. In the following description, when there is no need to distinguish the plurality of telecommunications devices 21, 22 from each other, those telecommunications devices 21, 22 will be hereinafter collectively referred to as “telecommunications devices 2.” Likewise, when there is no need to distinguish the plurality of devices 31, 32, 33 from each other, those devices 21, 22 will be hereinafter collectively referred to as “a plurality of devices 3.”

The telecommunications devices 2 each include a user interface having the function of accepting a person's operating command and the function of presenting information to a person. The action management system 1 may accept a person's operating command via the telecommunications device 2 and present various types of information to the telecommunications device 2 by communicating with the telecommunications device 2. In this embodiment, the telecommunications devices 2 include a touchscreen panel display as a user interface. For example, as shown in FIG. 1, the telecommunications device 21 may be the manager's X2 (e.g., mother's in this example) smartphone or tablet computer and the telecommunications device 22 may be a monitor installed in the facility F1.

The devices 3 are various types of devices (including utensils, equipment, appliances, and systems) which are either installed or used in the facility F1. For example, as shown in FIG. 2, the device 31 may be a toothbrush (smart toothbrush) that the target person X1 uses, the device 32 may be a washstand (smart washstand), and the device 33 may be a camera device.

Also, in this embodiment, the action management system 1 includes not only the generation unit 111 and the acquisition unit 112 but also an acceptance unit 113, a guidance unit 114, an arithmetic unit 115, a setting unit 116, a control unit 117, and a storage unit 118 as shown in FIG. 3. In this embodiment, each action module M1 includes a circuit block 11, which is provided with the generation unit 111, the acquisition unit 112, the acceptance unit 113, the guidance unit 114, the arithmetic unit 115, the setting unit 116, the control unit 117, and the storage unit 118. In other words, the circuit block 11 of each action module M1 has the functions of the generation unit 111, the acquisition unit 112, the acceptance unit 113, the guidance unit 114, the arithmetic unit 115, the setting unit 116, the control unit 117, and the storage unit 118.

The generation unit 111 generates a schedule D1 indicating an order in which the target person X1 is required to perform actions as described above. In addition, the generation unit 111 generates the schedule D1 in accordance with the arrangement order of the plurality of action modules M1. In this embodiment, the generation unit 111 stores, in the storage unit 118, the schedule D1 thus generated.

The acquisition unit 112 acquires an action log D2 indicating the execution status in which the target person X1 is following the schedule. In this embodiment, the acquisition unit 112 stores, in the storage unit 118, the action log D2 thus acquired.

The acceptance unit 113 embodies acceptance processing of the action management method. The acceptance processing is the processing of accepting, from the target person X1, an operating command indicating at least one of the beginning of an action or the end of the action. In other words, the action management method according to this embodiment further includes the acceptance processing of accepting, from the target person X1, the operating command indicating at least one of the beginning of an action or the end of the action. In this embodiment, the acceptance unit 113 accepts the target person's X1 operating command in response to an operating signal provided by an operating unit 12 to be described later.

The guidance unit 114 embodies guidance processing of the action management method. The guidance processing is processing of presenting, to the target person X1, guidance information about the actions to be performed following the schedule D1. In other words, the action management method according to this embodiment further includes the guidance processing of presenting, to the target person X1, the guidance information about the actions to be performed following the schedule. In this embodiment, the acceptance unit 113 presents the guidance information under the control of the control unit 117.

The arithmetic unit 115 embodies arithmetic processing of the action management method. The arithmetic processing is processing of generating arithmetic information based on the action log D2 by performing arithmetic operations on the action log D2. In other words, the action management method according to this embodiment further includes the arithmetic processing of generating arithmetic information based on the action log D2 by performing arithmetic operations on the action log D2. In this embodiment, the arithmetic unit 115 stores, in the storage unit 118, the arithmetic information thus generated.

The setting unit 116 embodies setting processing of the action management method. The setting processing is processing of setting a goal about the actions in association with the action modules M1. In other words, the action management method according to this embodiment includes the setting processing of setting a goal about the actions in association with the action modules M1. In this embodiment, the setting unit 116 stores, in the storage unit 118, the goal thus set.

The control unit 117 controls the devices 3 and a sound emission unit 15 or a light emission unit 16, for example, as will be described later. In this embodiment, the control unit 117 controls the devices 3, the sound emission unit 15, and the light emission unit 16 to have the guidance unit 114 present the guidance information, for example.

The storage unit 118 stores information required to allow the action management system 1 to operate. The storage unit 118 includes a programmable nonvolatile memory such as an electrically erasable programmable read-only memory (EEPROM). In this embodiment, the storage unit 118 stores at least the schedule D1 generated by the generation unit 111. In addition, the storage unit 118 further stores action identification information for use to identify the actions associated with the action modules M1.

In this embodiment, the circuit block 11 may be implemented as, for example, a computer system (which may be a server or a cloud computing system) including one or more processors and one or more memories. That is to say, each of the one or more processors performs the functions of the circuit block 11 by executing a program stored in any one of the one or more memories. The program may be stored in advance in the memory. Alternatively, the program may also be distributed after having been stored in a non-transitory storage medium such as a memory card or downloaded via a telecommunications line. In other words, the program is designed to make the one or more processors function as the circuit block 11.

Note that in this embodiment, the functions of the generation unit 111, the acquisition unit 112, the acceptance unit 113, the guidance unit 114, the arithmetic unit 115, the setting unit 116, the control unit 117, and the storage unit 118 are enabled only in the action module M1 serving as a master device. That is to say, in a state where the plurality of action modules M1 are combined together, those functions of the circuit block 11 are basically enabled only in the action module M1 serving as a master device and disabled in the other action modules M1 serving as slave devices, out of the plurality of action modules M1. This may prevent, in a state where the plurality of action modules M1 are combined together, two or more action modules M1 from attempting to perform the same function (e.g., attempting to serve as the generation unit 111 in parallel). Nevertheless, the functions required to be performed even in a slave device, e.g., the function of the acceptance unit 113 for accepting the operating command signal from the operating unit 12 and the function of the control unit 117 for controlling the sound emission unit 15 and the light emission unit 16, may be enabled as appropriate even in the action modules M1 serving as slave devices.

(2.3) Configuration for Action Modules

Next, a configuration for the action modules M1 according to this embodiment will be described with reference to FIGS. 2-4B.

Each of the plurality of action modules M11-M15 is associated with the target person's X1 action. In this embodiment, the action module M11 is associated with “clean up,” the action module M12 is associated with “meal,” the action module M14 is associated with “bath,” and the action module M15 is associated with “brush.” On the other hand, unlike the other action modules M1, the action module M13 is a “blank” action module M1 which is not associated with any action. That is to say, in the storage unit 118 of each action module M1, stored is action identification information that specifies an action to perform. For example, in the storage unit 118 of the action module M11, stored is action identification information that specifies the action “clean up.”

In this embodiment, each of the plurality of action modules M1 is a tangible object as described above. Thus, the arrangement order of the plurality of action modules M1 is determined by physically combining the plurality of action modules M1 with each other. That is to say, in this embodiment, tangible objects such as puzzle blocks or blocks that form a building blocks construction set are adopted as the action modules M1. Therefore, the plurality of action modules M1 may be physically combined together, which determines the arrangement order of the plurality of action modules M1. This makes it relatively easy for the target person X1 who is a kid to handle the plurality of action modules M1.

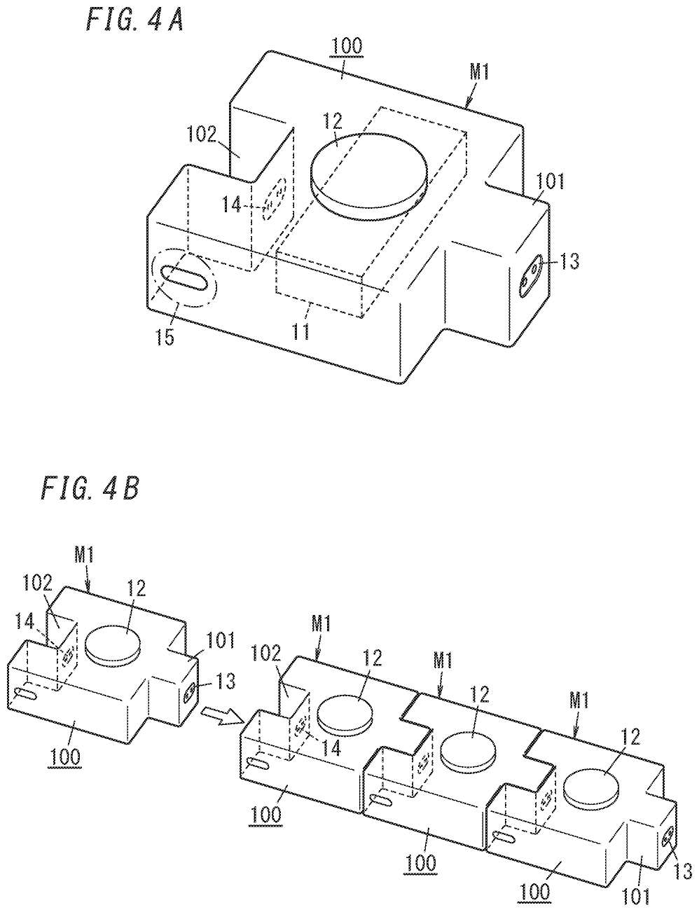

Specifically, the respective action modules M1 are configured as respective puzzle block pieces, which may be combined with each other as shown in FIGS. 4A and 4B. As used herein, the “puzzle block” is a type of block toy which allows a single structure to be formed by coupling multiple pieces of the puzzle block together. In this embodiment, each action module M1 includes a case 100 that forms the shell of the action module M1. As shown in FIG. 4A, the case 100 has a projection 101 on one end face in one direction (on the right end face in FIG. 4A) and a recess 102 on the other end face in the one direction (on the left end face in FIG. 4A). Thus, two action modules M1 may be joined (coupled) together by inserting and fitting the projection 101 of one action module M1 into the recess 102 of the other action module M1. Thus, the plurality of action modules M1 may be separably coupled together so as to be arranged in line in one direction as shown in FIG. 4B. In this embodiment, the arrangement direction of the plurality of action modules M1 coupled together is supposed to be the rightward/leftward direction (horizontal direction) as an example.

In this manner, the plurality of action modules M1 are coupled together (e.g., by fitting their projections into their recesses), thereby allowing an action management system 1 made up of the plurality of action modules M1 to be handled as a single structural body. In addition, the plurality of action modules M1 are separably coupled together by fitting their projections into their recesses. Thus, even after the plurality of action modules M1 have been combined (coupled) together once, the combination may be disassembled as well. This allows the plurality of action modules M1 to be rearranged, for example.

In addition, in each action module M1, a legend representing the associated action to perform (in the form of letters, signs, a figure or icon, or a combination thereof) is described on the front surface of the case 100 (see FIG. 2). For example, on the front surface of the case 100 of the action module M11 associated with “clean up,” the character string “clean up” is described as a legend. In the same way, on the action module M12 associated with “meal,” the character string “meal” is described as a legend. On the action module M14 associated with “bath,” the character string “bath” is described as a legend. On the action module M15 associated with “brush,” the character string “brush” is described as a legend. In this embodiment, the target person X1 is a kid, and therefore, a character string of hiragana letters, which is easy for the target person X1 (kid) to understand, is adopted as a legend. Nevertheless, the “blank” action module M13 is provided with no such legends. Furthermore, in this embodiment, the plurality of action modules M1 are painted in mutually different colors to make the plurality of action modules M1 easily distinguishable from each other.

Alternatively, a legend representing the action associated with each action module M1 may be freely given to the front surface of the case 100. The legend may be given by the manager X2, for example, either by directly writing (or drawing) the legend down on the front surface of the case 100 or coloring the front surface of the case 100. Alternatively, the legend may be given to the front surface of the case 100 by affixing a seal with the legend onto the front surface of the case 100. In that case, a keyword, which is usually used in a conversation between the manager X2 and the target person X1 (e.g., “num-num” in the case of “meal”) may be inscribed onto the front surface of the case 100. This allows a legend, taking the form of letters, signs, a figure or icon, or a combination thereof, which is easy for the target person X1 to understand, to be given to the action module M1. Giving the legend in the form of a figure or an icon allows even a target person X1 who is an illiterate kid to recognize the action associated with the action module M1.

Furthermore, in this embodiment, each action module M1 is configured to be fixable onto a wall surface of the facility F1 with an appropriate means such as a magnet or a sucking disc. Thus, as shown in FIG. 1, the plurality of action modules M1 may be mounted on a wall surface of a room so as to be joined together.

In the action management method according to this embodiment, the generation processing includes generating a schedule D1 indicating an order in which the target person X1 is required to perform respective actions in accordance with the arrangement order of the plurality of action modules M1 as described above. In addition, in this embodiment, the plurality of action modules M1 may be coupled together so as to be arranged in line in the rightward/leftward direction. Thus, the generation processing allows a schedule D1 to be generated in accordance with the arrangement order of the plurality of action modules M1 that are coupled together to be arranged side by side in line.

In this embodiment, one direction, pointing from the left to the right, of the rightward/leftward directions in which the plurality of action modules M1 that are joined together are arranged side by side corresponds to the time flow (time series). Specifically, as shown in FIG. 2, for example, the action “clean up” associated with the action module M11 located at the left end of the line consisting of the plurality of action modules M11-M15 is the first action to perform following the schedule D1. In the same way, the action “brush” associated with the action module M15 located at the right end of the line consisting of the plurality of action modules M11-M15 is the last action to perform following the schedule D1.

In addition, each action module M1 includes not only the circuit block 11 but also the operating unit 12, the first connection portion 13, the second connection portion 14, the sound emission unit 15, the light emission unit 16, and the communications unit 17 as shown in FIG. 3. The circuit block 11, the sound emission unit 15, the light emission unit 16, and the communications unit 17 are housed in the case 100. Nevertheless, the “blank” action module M1 is provided with no operating unit 12, sound emission unit 15, light emission unit 16, or communications unit 17 to say the least.

The operating unit 12 is operated by the target person X1. The operating unit 12 is arranged on the front surface of the case 100. In this embodiment, the operating unit 12 may be implemented as, for example, a momentary-type push button switch. The operating unit 12 suitably has a shape and size to be easily operated (pushed) by the target person X1.

The first connection portion 13 of each action module M1 is a terminal portion to be electrically connected to the second connection portion 14 of another action module M1. The circuit block 11 may sense whether or not the second connection portion 14 of another action module M1 is connected to the first connection portion 13. In this embodiment, the first connection portion 13 is arranged at a tip surface of the projection 101 of the case 100.

The second connection portion 14 of each action module M1 is a terminal portion to be electrically connected to the first connection portion 13 of another action module M1. The circuit block 11 may sense whether or not the first connection portion 13 of another action module M1 is connected to the second connection portion 14. In this embodiment, the second connection portion 14 is arranged at a bottom surface of the recess 102 of the case 100.

The sound emission unit 15 is controlled by the control unit 117 to emit various types of information as sounds (including voices) to the target person X1. In this embodiment, the sound emission unit 15 includes a loudspeaker, for example, which is housed in the case 100 so as to emit a sound through sound holes provided through one side surface of the case 100.

The light emission unit 16 is controlled by the control unit 117 to emit various types of information as light to the target person X1. In this embodiment, at least part of the case 100 has light transmitting properties, for example, and the light emission unit 16 includes a light-emitting diode (LED) and is housed in the case 100. That is to say, when the light emission unit 16 emits light inside the case 100, the light goes out of the case 100 by transmitting through at least a part of the case 100.

The communications unit 17 may communicate bidirectionally, over a network, for example, with the telecommunications devices 2, the plurality of devices 3, and the cloud computing system 4. In this embodiment, the communications unit 17 may adopt, for example, wireless communication using a radio wave as a communication medium such as Wi-Fi®, Bluetooth®, ZigBee®, or low power radio standard requiring no license (Specified Low Power Radio).

In this case, the action module M1 is suitably a battery-driven one. Therefore, in this embodiment, the action module M1 is supposed to, for example, include a storage battery and be powered by the electric energy stored in the storage battery.

(2.4) Action Management Method

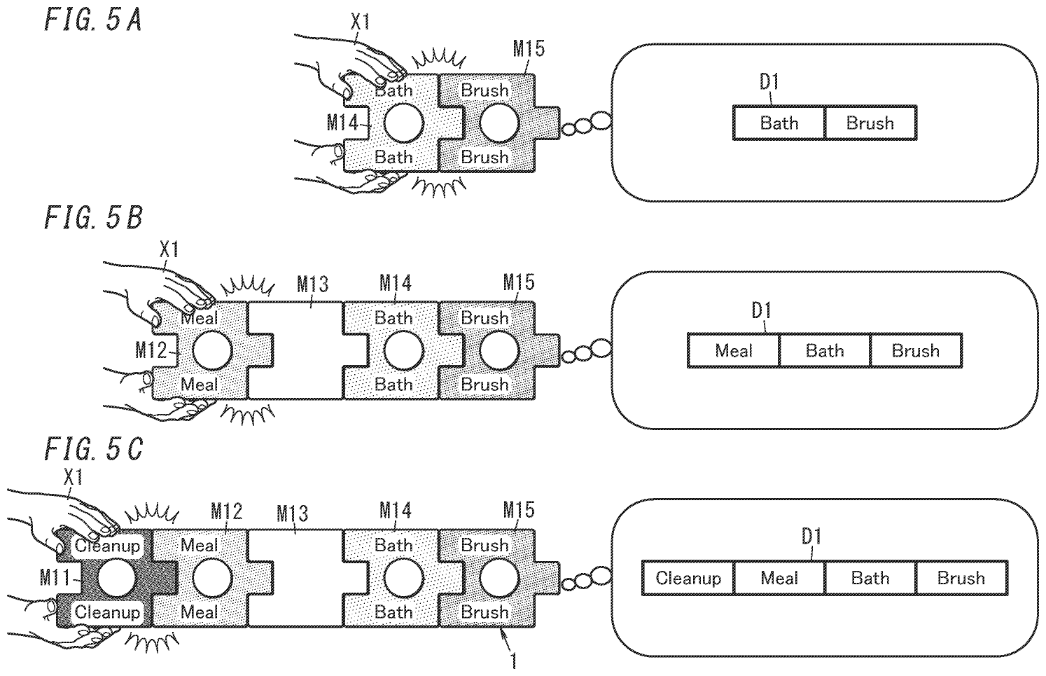

Next, an action management method according to this embodiment will be described with reference to FIGS. 5A-7.

(2.4.1) Generating Schedule

First of all, the generation processing of generating the schedule D1 of the action management method will be described with reference to FIGS. 5A-5C. FIGS. 5A-5C schematically illustrate how the schedule D1 is generated when the plurality of action modules M1 are arranged.

In this example, the schedule D1 is supposed to be set on a daily basis and also supposed to define the actions that the target person X1 should perform during some time range of the day (e.g., a few hours before and after dinner). Also, in this example, the job of setting the schedule D1, i.e., the job of arranging the plurality of action modules M11-M15, is supposed to be performed by the kid who is the target person X1 by him- or herself.

Also, in this embodiment, an action module M1, of which the first connection portion 13 is connected for the first time to another action module M1 among the plurality of action modules M1 in a state where there is no master device among the plurality of action modules M1 combined together, is defined to be the master device, as described above. In the example illustrated in FIGS. 5A-5C, the action module M1, of which the first connection portion 13 is connected for the first time to another action module M1 among the plurality of (e.g., five in this example) action modules M1 is an action module M14 associated with the action “bath.” Thus, the action module M14 is the master device. That is to say, in the example illustrated in FIGS. 5A-5C, the action module M14 serves as a master device, while all of the other action modules M11, M12, M13, and M15 serve as slave devices.

First of all, the target person X1 combines the action module M14 associated with “bath” with an action module M15 associated with “brush” as shown in FIG. 5A. In this case, the target person X1 combines the two action modules M14, M15 such that the action module M14 is located on the left of the action module M15. That is to say, these two action modules M14, M15 are coupled together by inserting and fitting the projection 101 of the action module M14 into the recess 102 of the action module M15. In this case, having the first connection portion 13 of the action module M14 electrically connected to the second connection portion 14 of the action module M15 allows each of the two action modules M14, M15 to detect the arrangement order of the two action modules M14, M15.

In this case, in the example illustrated in FIG. 5A, the two action modules M14, M15 are arranged in this order from left to right. Thus, the action module M14 serving as a master device makes the generation unit 111 generate the schedule D1 shown in FIG. 5A in accordance with the arrangement order of the action modules M14, M15. Specifically, the schedule D1 generated in FIG. 5A indicates the order in which the two actions “bath” and “brush” associated with the two action modules M14, M15 should be performed (i.e., in the order of “bath” and “brush”). Thus, in the state shown in FIG. 5A, the schedule D1 defining the order in which the target person X1 should perform actions is generated such that the actions “bath” and “brush” are performed in this order.

Next, the target person X1 combines an action module M12 associated with “meal” and a “blank” action module M13 with the action modules M14, M15 as shown in FIG. 5B. In this case, the target person X1 combines the four action modules M12-M14 such that the action module M12 is located on the left of the action module M14 with the action module M13 interposed between them. Specifically, first, the three action modules M13-M15 are coupled together by inserting and fitting the projection 101 of the action module M13 into the recess 102 of the action module M14. Next, the four action modules M13-M15 are coupled together by inserting and fitting the projection 101 of the action module M12 into the recess 102 of the action module M13.

In this case, having the first connection portion 13 of the action module M13 electrically connected to the second connection portion 14 of the action module M14 allows each of the two action modules M13, M14 to detect the arrangement order of the two action modules M13, M14. In the same way, having the first connection portion 13 of the action module M12 electrically connected to the second connection portion 14 of the action module M13 allows each of the two action modules M12, M13 to detect the arrangement order of the two action modules M12, M13. Therefore, at least the action module M14 serving as a master device may detect the arrangement order of the four action modules M12-M14.

In this case, in the example illustrated in FIG. 5B, the four action modules M12, M13, M14, and M15 are arranged in this order from left to right. Thus, the action module M14 serving as a master device makes the generation unit 111 generate the schedule D1 shown in FIG. 5B in accordance with the arrangement order of the four action modules M12-M15. Nevertheless, since the “blank” action module M13 is not associated with any action, the generation unit 111 generates the schedule D1 shown in FIG. 5B substantially in accordance with the arrangement order of the three action modules M12, M14, and M15. Specifically, the schedule D1 generated in FIG. 5B indicates the order in which the three actions “meal,” “bath,” and “brush” associated with the three action modules M12, M14, and M15 should be performed (i.e., in the order of “meal,” “bath,” and “brush”). Thus, in the state shown in FIG. 5B, the schedule D1 defining the order in which the target person X1 should perform actions is generated such that the actions “meal,” “bath” and “brush” are performed in this order.

Next, the target person X1 combines an action module M11 associated with “clean up” action with the action modules M12-M15 as shown in FIG. 5C. In this case, the target person X1 combines the five action modules M11-M14 such that the action module M11 is located on the left of the action module M12. That is to say, these five action modules M11-M15 are coupled together by inserting and fitting the projection 101 of the action module M11 into the recess 102 of the action module M12. In this case, having the first connection portion 13 of the action module M11 electrically connected to the second connection portion 14 of the action module M12 allows each of the two action modules M11, M12 to detect the arrangement order of the two action modules M11, M12. Therefore, at least the action module M14 serving as a master device may detect the arrangement order of the five action modules M11-M14.

In this case, in the example illustrated in FIG. 5C, the five action modules M11, M12, M13, M14, and M15 are arranged in this order from left to right. Thus, the action module M14 serving as a master device makes the generation unit 111 generate the schedule D1 shown in FIG. 5C in accordance with the arrangement order of the five action modules M11-M15.

Nevertheless, since the “blank” action module M13 is not associated with any action, the generation unit 111 generates the schedule D1 shown in FIG. 5C substantially in accordance with the arrangement order of the four action modules M11, M12, M14, and M15. Specifically, the schedule D1 generated in FIG. 5C indicates the order in which the four actions “clean up,” “meal,” “bath,” and “brush” associated with the four action modules M11, M12, M14, and M15 should be performed (i.e., in the order of “clean up,” “meal,” “bath,” and “brush”). Thus, in the state shown in FIG. 5C, the schedule D1 defining the order in which the target person X1 should perform actions is generated such that the actions “clean up,” “meal,” “bath” and “brush” are performed in this order.

The schedule D1 thus generated is stored as needed in the storage unit 118. That is to say, the schedule D1 stored in the storage unit 118 is updated from time to time as the target person X1 performs the jobs of arranging the plurality of action modules M1 from the state shown in FIG. 5A to the state shown in FIG. 5B and then to the state shown in FIG. 5C.

As described above, according to this embodiment, each of the plurality of action modules M1 is a tangible object. Thus, the arrangement order of the plurality of action modules M1 is determined by physically combining the plurality of action modules M1 with each other. In addition, the generation processing includes generating the schedule D1 in accordance with the arrangement order of the plurality of action modules M1 that are coupled together to be arranged in line.

As can be seen, the generation processing of this action management method allows a schedule D1 to be generated automatically in accordance with the arrangement order of the plurality of action modules M1 just by making the target person X1 do the simple job of arranging the plurality of action modules M1. This allows, even if the target person X1 is a kid, the target person X1 to set (generate) a schedule D1 relatively easily while enjoying the job as if he or she were playing with a toy or a game.

When finishing generating the schedule D1, the target person X1 fixes the combination of the plurality of action modules M1 onto, for example, a wall surface of the facility F1 while keeping the plurality of action modules M1 combined with each other. Thus, the plurality of action modules M1 are mounted onto the wall surface of the room while being joined together (see FIG. 1).

In addition, the schedule D1 generated by the action management system 1 is transmitted to the telecommunications device 2 at regular or irregular intervals or in response to a request from the telecommunications device 2. This allows the schedule D1 to be checked (viewed) on either the telecommunications device 21 such as the manager's X2 (e.g., mother's in this example) own smartphone or tablet computer or the telecommunications device 22 such as a monitor. Furthermore, the schedule D1 generated by the action management system 1 is also transmitted to the cloud computing system 4 at regular or irregular intervals or in response to a request from the cloud computing system 4. This allows the schedule D1 to be stored in the cloud computing system 4 as well.

Meanwhile, the schedule D1 generated by the action management method according to this embodiment includes order information but does not include time information. The time information indicates at least one of a start time of any one of the actions or an end time of the action. The order information indicates the order in which the actions are required to be performed. That is to say, the schedule D1 generated by the generation processing indicates only the order in which the target person X1 should perform actions in accordance with the arrangement order of the plurality of action modules M1 but does not specify the timings (times) when the target person X1 should start and/or finish performing the individual actions.

In other words, the schedule D1 takes a form with no concept of “time” such as the timing to start performing an action and/or the timing to finish performing the action. This allows the target person X1 to generate the schedule D1 without presenting the concept of “time” about the respective actions to the target person X1. In short, the target person X1 may generate the schedule D1 with the order of the actions to perform simply taken into account without being conscious of the concept of “time.” In addition, when performing actions, the target person X1 may perform the actions following the schedule D1 with the order of the actions to perform simply taken into account without being conscious of the concept of “time.” As can be seen, this schedule D1 defines only the order in which the target person X1 needs to perform the actions. Thus, it is relatively easy for the target person X1 to set the schedule D1. In addition, this reduces the chances of the schedule D1 excessively binding the target person's X1 actions. Consequently, this facilitates the target person X1 performing the actions following the schedule D1.

Such a schedule D1 is generated on a daily basis. For example, the target person X1 may set a schedule D1 for the next day before going to bed every day. Alternatively, the target person X1 may set a schedule D1 for the day after he or she has got up every day.

(2.4.2) Following Schedule

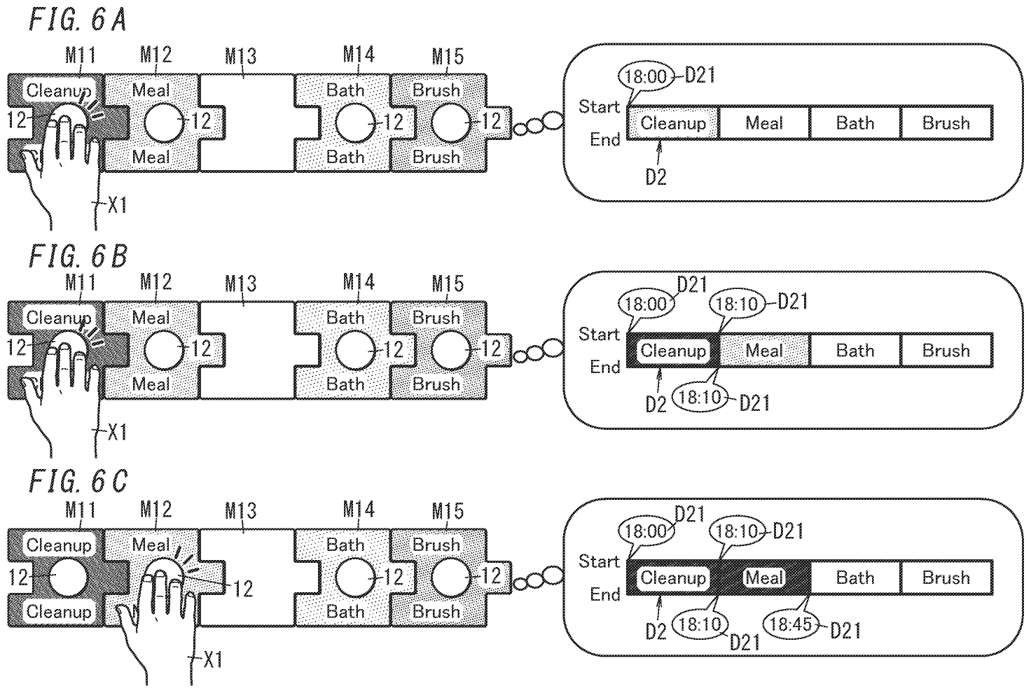

Next, the processing to be performed when the target person X1 is following the schedule D1 while carrying out the action management method will be described with reference to FIGS. 6A-6C. FIGS. 6A-6C schematically illustrate how an action log D2 is generated in accordance with the target person's X1 operation on the plurality of action modules M1. In the example to be described below, a kid who is the target person X1 is supposed to perform the actions following the schedule D1 generated at a point in time shown in FIG. 5C, which has already been described in the “(2.4.1) Generating schedule” section.

Also, the action management method according to this embodiment includes acceptance processing of accepting the target person's X1 operating command specifying at least one of the beginning of an action or the end of the action. In this case, when following the schedule D1 (i.e., when performing any of the plurality of actions, of which the order is defined by the schedule D1), the target person X1 operates the operating unit 12 of the action module M1 associated with the action. In particular, the target person X1 is supposed to operate the operating unit 12 at a point in time when he or she starts and/or finishes performing each action. Furthermore, in the example illustrated in FIGS. 6A-6C, the action log D2 indicates an action being performed by a light shade (such as “meal” shown in FIG. 6B) and indicates an action performed (done) by a dark shade (such as “clean up” shown in FIG. 6B).

Specifically, when starting performing the action “clean up,” for example, among the actions, of which the order is defined by the schedule D1, the target person X1 operates the operating unit 12 of the action module M11 associated with the action “clean up” as shown in FIG. 6A. At this time, the acquisition unit 112 acquires an action log D2 about the execution status of the schedule D1 by the target person X1. Specifically, in the example illustrated in FIG. 6A, the beginning of the action “clean up” associated with the action module M11 may be detected by sensing that the operating unit 12 of the action module M11 has been operated. Thus, in the state shown in FIG. 6A, acquired is an action log D2 indicating, as the execution status of the schedule D1, that the action “clean up,” which is the first action to perform according to the schedule D1 indicating the order of the actions as “clean up,” “meal,” “bath,” and “brush,” is being performed.

Thereafter, when finishing the action “clean up,” the target person X1 operates the operating unit 12 of the action module M11 associated with the action “clean up” as shown in FIG. 6B. At this time, the acquisition unit 112 acquires an action log D2 about the execution status of the schedule D1 by the target person X1. Specifically, in the example shown in FIG. 6B, the end of the action “clean up” associated with the action module M11 may be detected by sensing that the operating unit 12 of the action module M11 associated with the action being performed has been operated.

In addition, in the action management method according to this embodiment, “automatic change” which regards, when accepting an operating command indicating the end of an action, that an operation indicating the beginning of an action next to the action ended has been performed, is adopted. Specifically, in a situation where the schedule D1 defines that the two actions “clean up” and “meal” should be performed in this order, if an operating command indicating the end of the action “clean up” is accepted, then it means that the operation indicating the beginning of the next action “meal” has been accepted because the “automatic change” function is activated. Thus, when the target person X1 finishes performing one of the two actions to start the other action, the target person X1 only needs to perform an operation indicating the end of the one action and may omit performing an operation indicating the beginning of the other action.

Thus, as shown in FIG. 6B, when the operating unit 12 of the action module M11 is operated, it means that the operating unit 12 of the action module M12 associated with the next action “meal” has been operated because the “automatic change” function is activated. Thus, in the example shown in FIG. 6B, the beginning of the action “meal” associated with the action module M12 may be detected by sensing that the operating unit 12 of the action module M11 has been operated.

Therefore, in the state shown in FIG. 6B, an action log D2 indicating, as an execution status of the schedule D1, that the first action “clean up” has been finished and the second action “meal” is being performed is acquired.

Thereafter, when finishing the action “meal,” the target person X1 operates the operating unit 12 of the action module M12 associated with the action “meal” as shown in FIG. 6C. At this time, the acquisition unit 112 acquires an action log D2 about the execution status of the schedule D1 by the target person X1. Specifically, in the example shown in FIG. 6C, the end of the action “meal” associated with the action module M12 may be detected by sensing that the operating unit 12 of the action module M12 associated with the action being performed has been operated.

In this case, when an operating command indicating the end of an action is accepted, an operating command indicating the beginning of an action next to the action ended may usually be regarded as having been accepted, as long as the “automatic change” function is activated. However, an action module M14 associated with the next action “bath” is coupled to the action module M12 associated with the action “meal” with the “blank” action module M13 interposed between them. Thus, interposing the “blank” action module M13 deactivates the “automatic change” function. In other words, in a situation where two action modules M1 are arranged side by side as a first action module and a second action module, respectively, when an operating command indicating the end of an action associated with the first action module is accepted, an operating command indicating the beginning of an action associated with the second action module may usually be regarded as having been accepted. Nevertheless, if a “blank” action module M1 associated with no action is inserted between these two action modules M1, then the “automatic change” function is deactivated. With the “automatic change” function deactivated, even when an operating command indicating the end of an action associated with the first action module M1 is accepted, an operating command indicating the beginning of an action associated with the second action module M1 is not regarded as having been accepted. Thus, in the example illustrated in FIG. 6C, the beginning of the action “bath” associated with the action module M14 is not detected by sensing that the operating unit 12 of the action module M12 has been operated.

Thus, in the state shown in FIG. 6C, an action log D2 indicating, as an execution status of the schedule D1, the end of the first action “clean up” and the end of the second action “meal” is acquired.

The action log D2 thus acquired is stored as needed in the storage unit 118. In other words, as the actions are performed sequentially following the schedule D1 from the state shown in FIG. 6A to the state shown in FIG. 6B and then to the state shown in FIG. 6C, the action log D2 stored in the storage unit 118 is updated as needed.

In addition, the action log D2 acquired by the action management system 1 is transmitted to the telecommunications device 2 at regular or irregular intervals or in response to a request from the telecommunications device 2. This allows the action log D2 to be checked (viewed) on either the telecommunications device 21 such as the manager's X2 (e.g., mother's in this example) own smartphone or tablet computer or the telecommunications device 22 such as a monitor. Furthermore, the action log D2 generated by the action management system 1 is also transmitted to the cloud computing system 4 at regular or irregular intervals or in response to a request from the cloud computing system 4. This allows the action log D2 to be stored in the cloud computing system 4 as well.

Accumulating action logs D2 of this type in the cloud computing system 4 allows the action logs D2 to be expanded in various applications. For example, the degree of concentration (or absorption) of the kid who is the target person X1 in “playing with toys” may be estimated based on the start and end times of his or her action “playing with toys.” The result thus obtained may be reflected in the development of educational toys in which the target person X1 is often interested. In addition, based on the start and end times of the action “brush,” the cumulative time of “brush” that the target person X1 has spent may be calculated to estimate the degree of wear of the device 31 (toothbrush) and consumption of consumables such as toothpaste. The result thus obtained may be reflected on the management of the consumables.

Meanwhile, according to this embodiment, the action log D2 includes timing information D21 about at least one of a timing indicating the beginning of an action or a timing indicating the end of the action. Specifically, when the operating unit 12 is operated and the acceptance unit 113 receives an operating command signal indicating the beginning of an action from the operating unit 12, the acquisition unit 112 acquires the point in time and adds information about that time, as timing information D21 indicating the start time of the action, to the action log D2. In the same way, when the operating unit 12 is operated and the acceptance unit 113 receives an operating command signal indicating the end of an action from the operating unit 12, the acquisition unit 112 acquires the point in time and adds information about that time, as timing information D21 indicating the end time of the action, to the action log D2.

Thus, in the example illustrated in FIG. 6A, the action log D2 includes timing information D21 indicating the start time (which may be 18:00, for example) of “clean up.” In the example illustrated in FIG. 6B, the action log D2 includes timing information D21 indicating not only the start time of “clean up” but also the end time (which may be 18:10, for example) of “clean up” and the start time (which may be 18:10, for example) of “meal.” In the example illustrated in FIG. 6C, the action log D2 includes timing information D21 indicating not only the start time and end time of “clean up” and the start time of “meal” but also the end time (which may be 18:45, for example) of “meal.”

The action management method according to this embodiment further includes guidance processing of presenting, to the target person X1, guidance information about the actions being performed by the target person X1 following the schedule D1. The guidance information may be some piece of information about an action being performed. The guidance information is output from, for example, one of the devices 3, the sound emission unit 15, or the light emission unit 16.

Specifically, when the operating unit 12 is operated to have the acceptance unit 113 receive an operating command signal indicating the beginning of an action from the operating unit 12, the guidance unit 114 starts presenting, under the control of the control unit 117, the guidance information about the action being performed. Thereafter, when the acceptance unit 113 receives an operating command signal indicating the end of the action from the operating unit 12, the guidance unit 114 finishes presenting the guidance information about the action being performed. Thus, while the target person X1 is performing the action, guidance information about the action is presented to the target person X1.

For example, as shown in FIG. 6A, when the operating unit 12 of the action module M11 is operated, the guidance information about the action being performed, i.e., the guidance information about an action “cleanup” associated with the action module M11 is presented to the target person X1. The guidance information about the action “cleanup” includes, for example, information provided by the sound emission unit 15 or light emission unit 16 of the action module M11 associated with the action “cleanup.” For example, in the action module M11, a sound prompting the target person X1 to “clean up” (such as a melody, a beep, or a voice message) may be emitted from the sound emission unit 15 and light may be emitted from the light emission unit 16, thereby providing the guidance information from the action module M11.

In the same way, in the state shown in FIG. 6B, when the operating unit 12 of the action module M12 is operated, the guidance information about the action being performed, i.e., the guidance information about an action “meal” associated with the action module M12, is presented to the target person X1. The guidance information about the action “meal” includes, for example, information provided by the sound emission unit 15 or light emission unit 16 of the action module M12 associated with the action “meal.” For example, in the action module M12, a sound prompting the target person X1 to take a “meal” (such as a melody, a beep, or a voice message) may be emitted from the sound emission unit 15 and light may be emitted from the light emission unit 16, thereby providing the guidance information from the action module M12.

In the embodiment described above, the guidance information is provided by one of the action modules M1 by itself. However, this configuration is only an example and should not be construed as limiting. Alternatively, the guidance information may also be provided by one of the devices 3. For example, the guidance information about the action “toothbrush” may include guidance information provided by the device 31 that is a toothbrush used by the target person X1 or guidance information provided by the device 32 that is a washstand. As a specific example, a “toothbrushing” sound (such as a melody, a beep, or a voice message) may be emitted from the device 31 that is a toothbrush and/or video cheering or supporting the target person X1 with toothbrushing may be displayed on the mirror of the device 32 that is a washstand, thereby presenting the guidance information.

In this case, the guidance information is suitably a piece of information that has the effect of attracting the target person's X1 attention to the action that he or she is now performing. Examples of such guidance information include information with the voice or video of a cartoon animation character that the target person X1 likes. In addition, in this guidance processing, such guidance information is suitably presented continuously, not intermittently, while the target person X1 is performing the action. This facilitates keeping the target person X1 motivated to deal with the action he or she is currently doing, thus eventually prompting the target person X1 to follow the schedule D1.

Also, in the guidance processing, the mode of presenting the guidance information is suitably changed according to the execution status of the action by the target person X1. As used herein, the “mode of presentation” includes the way in which the guidance information is presented and the contents of the guidance information itself. For example, changing the mode of presentation of the guidance information according to the time that has elapsed since the beginning of the action and/or the degree of concentration of the target person X1 in the action contributes to increasing the efficiency with which the target person X1 performs the action. For example, in the state shown in FIG. 6A, as for the guidance information presented while the action “cleanup” is being performed, the sound emitted from the sound emission unit 15 may be changed or the light emission pattern (such as a flickering period) of the light emission unit 16 may be changed when a predetermined period of time passes since the beginning of the action (cleanup).

Optionally, the mode of presentation of the guidance information may be changed depending on the execution status of the action. For example, the mode of presentation of the guidance information at the beginning of the action may be different from that of the guidance information at the end of the action. Specifically, at the beginning of an action, the target person X1 is suitably motivated toward the action by emitting a voice message such as “do your best to clean up the mess as always” from the sound emission unit 15 to cheer and support the target person X1 with his or her action. On the other hand, at the end of the action, the target person X1 is suitably compensated for his or her effort at fulfilling the action by emitting a voice message such as “good job!” from the sound emission unit 15 to praise his or her performance of the action.

Optionally, the mode of presentation of the guidance information may also be changed according to the execution status of the action that was performed in the past, instead of the execution status of the ongoing action. For example, in the state shown in FIG. 6B, as for the guidance information presented while the action “meal” is being performed, its mode of presentation may be changed according to the execution status of the previous action “cleanup” such as the time it has taken for the target person X1 to get the action done and/or the degree of concentration of the target person X1 in the action. Specifically, if the action “cleanup” has been done in less than 10 minutes, the light emission unit 16 may be flashed in rainbow colors while the target person X1 is performing the action “meal”. On the other hand, if it has taken 10 minutes or more for the target person X1 to get the action “cleanup” done, then the light emission unit 16 may be flashed in white as the guidance information to present while the target person X1 is performing the action “meal.”

As can be seen, changing the mode of presenting the guidance information according to the execution status of the action by the target person X1 in this manner facilitates keeping the target person X1 motivated to deal with the action he or she is currently doing, thus eventually prompting him or her to follow the schedule D1.

Still alternatively, the mode of presenting the guidance information may also be changed depending on the timing (which may be a time range of the day, the day of the week, the month of the year, or a season, for example) when the target person X1 begins (or finishes) the action. For example, if the time range in which the target person X1 has begun the action is in the morning, then a musical tune having the effect of waking the target person X1 up may be emitted from the sound emission unit 15 and presented as the guidance information. On the other hand, if the time range in which the target person X1 has begun the action is in the night, then a musical tune having a healing effect may be emitted from the sound emission unit 15 and presented as the guidance information. Alternatively, if the day when the target person X1 has begun the action is Christmas, then light simulating Christmas illuminations may be emitted from the light emission unit 16 and presented as the guidance information.

(2.4.3) Other Functions

Furthermore, the action management method according to this embodiment also has the following additional functions.

A first additional function of the action management method enables acquiring, for example, the beginning, end, and execution status of an action automatically without depending on the target person's X1 operation. For example, the beginning, end, and execution status of an action may also be detected by estimating the target person's X1 action based on the video shot by the device 33 that is a camera device, even without making the target person X1 operate the operating unit 12. Likewise, the beginning, end, and execution status of an action may also be detected depending on the status of use of the devices 3 that the target person X1 uses to perform the action (e.g., “toothbrushing” in this case) such as the device 31 that is a toothbrush and the device 32 that is a washstand.

A second additional function of the action management method is providing the action log D2 with target person information about the status of the target person X1 who is performing an action. As used herein, the “target person information” is information about the status of the target person X1 and includes, for example, pieces of information about the degree of concentration of the target person X1 in the action, his or her interest in (or his or her concern about) the action, the place where the target person X1 performed the action, and the facial expression and humor of the target person X1 who is performing the action. In this case, the degree of concentration of the target person X1 in the action, his or her interest in (or his or her concern about) the action, and the facial expression and humor of the target person X1 who is performing the action may be estimated based on the video shot by the device 33 that is a camera device. For example, if the target person X1 is currently located distant from the place where the target person X1 is supposed to perform the action “toothbrushing,” it is presumed that the degree of his or her concentration should be low or that he or she should have no interest (or concern). Providing the action log D2 with such target person information allows the manager X2 to learn, based on the action log D2, not only the execution status of the schedule D1 but also the appearance of the target person X1 who has performed the action.

A third additional function is that the action management method includes arithmetic processing of generating arithmetic information based on the action log D2 by performing arithmetic operations on the action log D2. That is to say, arithmetic information different from the action log D2 itself may be generated by making the arithmetic unit 115 perform some type of arithmetic operation on the action log D2. As an example, the arithmetic processing may include generating the arithmetic information by calculating, based on the action log D2, an average value during a monitoring period (of one month, for example) or a comparative value (i.e., the differential value) with a particular day (previous day), for example, with respect to the start (or end) time of each action and the time it takes to perform the action, for example. Using such arithmetic information facilitates, for example, evaluating the degree of improvement in the execution status in which the target person X1 is following the schedule D1.

Also, if the target person X1 includes a plurality of persons, then the arithmetic information includes statistical information to be generated based on, at least, the action log D2 with respect to each of the plurality of target persons X1. That is to say, the arithmetic processing includes collecting the action logs D2 of the plurality of target persons X1 and generating, as the arithmetic information, statistical information obtained based on the action logs D2 with respect to the plurality of persons. As used herein, the “statistical information” is information generated by subjecting the plurality of action logs D2, respectively associated with the plurality of target persons X1, to the arithmetic processing. Examples of the statistical information include the average value, median value, mode value, minimum value or maximum value, and dispersion or standard deviation with respect to the plurality of target persons X1 in terms of the start (or end) time of each action and the time it takes to get the action done. As for the plurality of target persons X1 for which the statistical information is calculated, a plurality of target persons X1, which share some parameter such as their age, gender, or place of residence in common, are suitably selected from among multiple target persons X1 as the users of the action management method. Such statistical information allows the manager X2 to learn about the statistical statuses of the plurality of target persons X1, thus facilitating evaluating the degrees of improvement in the execution statuses in which the target persons X1 are following the schedule D1.

The statistical information further includes comparative information representing evaluation of a particular target person X1 relative to a plurality of target persons X1. That is to say, the arithmetic processing includes, generating, when obtaining statistical information based on the plurality of action logs D2 respectively associated with the plurality of target persons X1, comparative information as the statistical information about the particular target person X1 by comparing the particular target person X1 with the plurality of target persons X1. As used herein, the “comparative information” is information represented by comparing the action logs D2 of the plurality of target persons X1 with the action log D2 of the particular target person X1. Examples of the comparative information include the rank (place in the standing) of the particular target person X1 among the plurality of target persons X1, the deviation of the particular target person X1 among the plurality of target persons X1, and the difference of the target person X1 from the average value of the plurality of target persons X1 in terms of the start (or end) time of each action and the time it takes to get the action done. As used herein, the “particular target person X1” may or may not be included in the plurality of target persons X1, for which the statistical information is calculated. Providing such comparative information facilitates evaluating the degree of improvement in the execution status in which the particular target person X1 is following the schedule D1, as compared with the other target persons X1, for example.

In this case, the arithmetic information (including statistical information and comparative information) obtained by the arithmetic processing is transmitted to the telecommunications device 2 at regular or irregular intervals or in response to a request from the telecommunications device 2. This allows the arithmetic information to be checked (viewed) on either the telecommunications device 21 such as the manager's X2 (e.g., mother's in this example) own smartphone or tablet computer or the telecommunications device 22 such as a monitor. Furthermore, the arithmetic information generated by the action management system 1 is also transmitted to the cloud computing system 4 at regular or irregular intervals or in response to a request from the cloud computing system 4. This allows the arithmetic information to be stored in the cloud computing system 4 as well.

Also, if the target person information is included in the action log D2 as described above as the second additional function, then the arithmetic information (including the statistical information and comparative information) is suitably stored in the cloud computing system 4, for example, to be associated with the target person information. For example, statistical information (including comparative information) may be generated on the basis of each degree of the target person's X1 concentration in the action and may be saved to be associated with the target person information about the degree of concentration. This allows the statistical information and other pieces of information to be collected on the basis of the target person's X1 status (such as his or her degree of concentration), thus enabling the correlation between the target person's X1 status and the action log D2 or the rank of the target person X1 based on his or her status to be obtained.

A fourth additional function is that the action management method includes setting processing of setting a goal about each action in association with the action module M1. That is to say, making the setting unit 116 set some goal (in the form of a target value) in association with the action module M1 allows a goal to be set with respect to each of the actions defined by the schedule D1. For example, the setting processing includes setting, as a goal about an action, a target start (or end) time of the action or the target time it takes to get the action done. Setting the goal may motivate the target person X1 toward the action, for example. The mode of presentation of the guidance information, for example, is suitably changed depending on the degree of achievement of the goal, i.e., depending on whether or not the goal is accomplished.

A fifth additional function of the action management method is allowing the manager X2 to enter various settings and operating commands into the action management system 1 via the telecommunications device 2. For example, the manager X2 (e.g., the mother) is allowed to set the goal in the setting processing described above and/or set the mode of presentation of the guidance information (including the contents of the guidance information) using the telecommunications device 21 such as her own smartphone or tablet computer. Optionally, the action module M1 may also be remote controlled by the telecommunications device 21, instead of being operated by the operating unit 12 of the action module M1. Furthermore, as for the action log D2, information such as the target person information, for example, may be entered via the telecommunications device 2. In that case, the manager X2 (e.g., the mother in this case) may manually enter, as the target person information, information about the target person's X1 facial expression and humor, for example, and add the target person information to the action log D2 by using the telecommunications device 21.

The action management method according to this embodiment further includes output processing including providing a particular terminal with output information including the action logs D2 and the arithmetic information at least partially. As used herein, the “particular terminal” may be the telecommunications device 2 or the cloud computing system 4, or any other type of terminal. Specifically, the particular terminal is supposed to be a terminal (including a server or a cloud computing system) owned or used by a third party, for example (i.e., a party who is neither the target person X1 nor the manager X2), and the action management system 1 provides (transmits) the output information to the particular terminal. In this case, the action management system 1 transmits the output information to the particular terminal at regular or irregular intervals or in response to a request from the particular terminal. This allows the information (such as the action logs D2 or arithmetic information) obtained by the action management method to be used for, for example, development of products or expansion of services with which a third party is involved. Nevertheless, when the output information is provided for the particular terminal, the privacy of the persons concerned (namely, the target person X1 and the manager X2) is suitably respected either by encrypting the output information or transforming the output information into unidentifiable, anonymous information. As used herein, the “unidentifiable, anonymous information” refers to personal information that has been transformed to discourage a third party from identifying a particular individual based on the personal information (i.e., by restoring his or her personal information).

A sixth additional function is that the action management method further includes list displaying processing of displaying, as a list, information based on the action logs D2 acquired through the acquisition processing performed on a plurality of target persons X1. According to this sixth additional function, there supposed to be a plurality of target persons X1. As used herein, the “information based on the action logs D2” includes the action logs D2 themselves and information generated based on the action logs D2 such as the arithmetic information (including statistical information and comparative information). Also, as used herein, the “list display” refers to a mode of display in general, in which a single display means allows the viewer to check multiple items of information at a time (i.e., any mode of display in general in which multiple items of information are provided in a summarized form to give the viewer an overview of those items of information). Examples of specific modes of the “list display” include not only a mode in which multiple items of information are displayed side by side on a single screen but also a mode in which multiple items of information may be displayed by scrolling up or down the screen and a mode in which links for use to access the multiple items of information are displayed within a single screen.

For example, suppose a situation where the kids living in the facility F1 are brothers and there are three target persons X1 who are the first son, second son, and third son, respectively. In that case, in the list displaying processing of the action management method, the action log D2 of the first son, the action log D2 of the second son, and the action log D2 of the third son are displayed as a list. In the list displaying processing, information based on the action logs D2 of multiple persons may be displayed as a list on a single display means such as the telecommunications device 2. This allows the manager X2, for example, to simultaneously check the respective schedules D1 of the plurality of target persons X1 and the execution statuses thereof. Thus, when there are a plurality of target persons X1 such as family members, lodgers, or live-ins, the manager X2 may learn about the correlation between the plurality of target persons X1 more easily in terms of the schedules D1 and the execution statuses thereof. In this case, the plurality of target persons X1, whose information needs to be displayed as a list, do not have to form a family living in the same facility F1 but may also be relatives (such as cousins) or friends living separately in different facilities F1.

Note that respective additional functions such as the ones described above are not essential constituent features of the action management method but may be omitted as appropriate.

(2.4.4) Flowchart

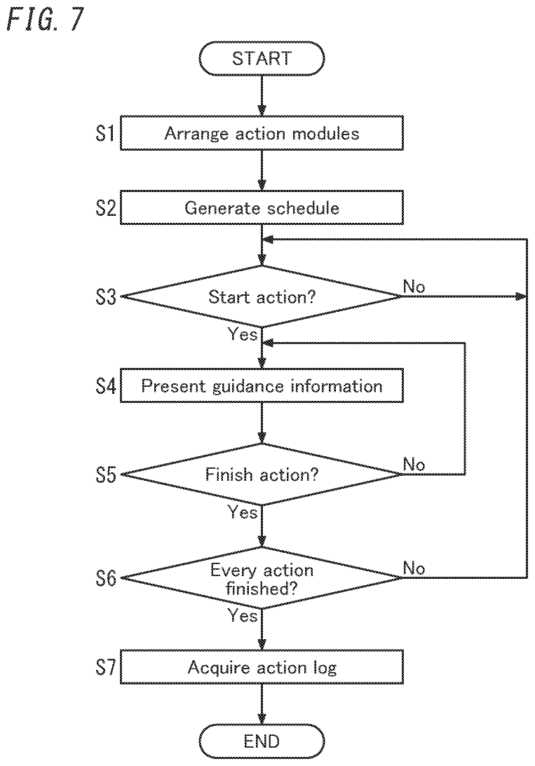

FIG. 7 is a flowchart of the action management method described above.

Specifically, in the action management method according to this embodiment, first, the target person X1 arranges the plurality of action modules M1 (in 51). When the plurality of action modules M1 are arranged, generation processing is performed to generate a schedule D1 in accordance with the arrangement order of the plurality of action modules M1 (in S2). The schedule D1 thus generated is stored in the storage unit 118.

Thereafter, a determination is made, in accordance with an operating command that may or may not have been entered through the operating unit 12 of one of the action modules M1, whether or not any action needs to be started (in S3). If no operating command to start performing an action has been received from the target person X1 (if the answer is NO in S3), then this processing step S3 is performed all over again. On the other hand, if any operating command to start performing an action has been received from the target person X1 through the acceptance processing (if the answer is YES in S3), then guidance processing of presenting, to the target person X1, guidance information about the action that the target person X1 has started is performed (in S4).

Subsequently, a determination is made, in accordance with an operating command that may or may not have been entered through the operating unit 12 of one of the action modules M1, whether or not any action needs to be finished (in S5). If no operating command to finish performing an action has been received from the target person X1 (if the answer is NO in S5), then this processing step S4 is performed all over again. On the other hand, if any operating command to finish performing an action has been received from the target person X1 through the acceptance processing (if the answer is YES in S5), then a determination is made whether or not every action defined by the schedule D1 has been finished (in S6). If not every action has been finished yet (if the answer is NO in S6), then the process goes back to the processing step S3. On the other hand, if every action has been finished (if the answer is YES in S6), then the action log D2 is acquired through the acquisition processing (in S7). The action log D2 thus acquired is stored in the storage unit 118.

Note that the flowchart shown in FIG. 7 gives only an exemplary procedure of the action management method and should not be construed as limiting. Optionally, one of the processing steps may be omitted, any additional processing step may be performed, or the processing steps may be performed in an appropriately modified order.

### (3) Variations

Note that the first embodiment described above is only an exemplary one of various embodiments of the present disclosure and should not be construed as limiting. Rather, the first embodiment may be readily modified in various manners depending on a design choice or any other factor without departing from the scope of the present disclosure. The drawings to be referred to in this description are all schematic representations. The ratio of the dimensions (including thicknesses) of respective constituent elements illustrated on the drawings does not always reflect their actual dimensional ratio. The functions of the action management method according to the first embodiment described above may also be implemented as, for example, a (computer) program, or a non-transitory storage medium that stores the program. A program according to an aspect is designed to cause one or more processors to perform the action management method described above.

Next, variations of the first embodiment will be enumerated one after another. The variations to be described below may be adopted in combination as appropriate.

The action management system 1 according to the present disclosure includes a computer system. The computer system may include a processor and a memory as principal hardware components. The functions of the action management system 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be implemented as a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra-large scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, at least some of the plurality of constituent elements (or the functions) of the action management system 1 are integrated together in a single housing. However, this is not an essential configuration for the action management system 1. Alternatively, those constituent elements (or functions) of the action management system 1 may be distributed in multiple different housings. For example, the generation unit 111 may be provided in a different housing from the acquisition unit 112. Alternatively, the functions of the generation unit 111, the acquisition unit 112, and other units may also be provided for a server or any other device provided separately from the action modules M1. Still alternatively, at least some functions of the action management system 1, such as the functions of the generation unit 111, the acquisition unit 112, and other units, may be implemented as a cloud computing system as well.

Conversely, at least some functions, distributed among a plurality of devices in the first embodiment, may be integrated together in a single housing.

In the embodiment described above, the target person X1 is supposed to be a kid. However, this is not an essential feature of the action management method. Alternatively, the target person X1 may also be any other type of person, not just a kid. Examples of various types of target persons X1 whose actions are to be managed by the action management method include children including infants and kids, persons with cognitive impairment, and senior persons with mild cognitive impairment (MCI).

Furthermore, the number of the target persons X1 does not have to be one but may also be plural. For example, if there are a plurality of kids (such as brothers) living in the same facility F1, then the plurality of kids may be target persons X1. In that case, the generation processing of the action management method suitably includes generating their respective schedules D1 for the plurality of target persons X1 on an individual basis or generating a single common schedule D1 for all of the plurality of target persons X1. Specifically, in the former case, generating individual schedules D1 for the plurality of target persons X1 allows the order in which the plurality of target persons X1 perform their actions to be defined on an individual basis by the plurality of schedules D1. On the other hand, in the latter case, generating a single common schedule D1 for the plurality of target persons X1 allows the order in which the plurality of target persons X1 perform their actions to be defined collectively by the single schedule D1. In the same way, the acquisition processing suitably includes acquiring their respective action logs D2 for the plurality of target persons X1 on an individual basis or acquiring a single common action log D2 for all of the plurality of target persons X1. Specifically, in the former case, the manager X2 may check the respective execution statuses of the schedules D1 with respect to the plurality of target persons X1 on an individual basis. In the latter case, the manager X2 may check the execution status of the single schedule D1 with respect to the plurality of target persons X1 as a whole.

Also, the action management method does not always have to be used in the dwelling house F1 but may also be used in a non-dwelling facility such as a nursery school, a kindergarten, a school, a welfare facility, a hospital, rehabilitation center, an office, or a store. For example, when the action management is used in a nursery school, a single or a plurality of nursery school kid(s) is/are the target person(s) X1. If a plurality of nursery school kids are the target persons X1, the generation processing of the action management method suitably includes generating their respective schedules D1 for the target persons X1 on an individual basis or generating a single common schedule D1 for all of the plurality of target persons X1. In the same way, the acquisition processing suitably includes acquiring their respective action logs for the target persons X1 on an individual basis or acquiring a single common action log D2 for all of the plurality of target persons X1.

Furthermore, in the embodiment described above, when a plurality of action modules M1 are combined together, any one of the plurality of action modules M1 is supposed to serve as a master device. However, this is not an essential configuration. Alternatively, for example, two or more action modules M1 may serve as master devices. Still alternatively, the action modules M1 do not have to be classified into a master device and slave devices in the first place. That is to say, if the functions of the generation unit 111 and the acquisition unit 112 are provided for a device (such as a server) provided separately from the action module M1, then there is no need to classify the action modules M1 into a master device and slave devices.

Furthermore, in the first embodiment described above, the plurality of action modules M1 have the same shape in common. However, this is only an example and should not be construed as limiting. Alternatively, the plurality of action modules M1 may have mutually different shapes. In addition, the plurality of action modules M1 do not have to be arranged in the rightward/leftward direction (horizontal direction) but may also be arranged in the upward/downward direction (vertical direction). When the plurality of action modules M1 are arranged in the upward/downward direction, the plurality of action modules M1 are piled up like blocks that form a building blocks construction set to form a tower like structure. Furthermore, the plurality of action modules M1 may also be configured to form a stereoscopic structure when combined three-dimensionally.

In addition, in the embodiment described above, the plurality of action module M1 are supposed to be joined together. However, this configuration is not an essential one. Alternatively, the plurality of action modules M1 may also be simply arranged or piled up. Optionally, when the plurality of action modules M1 are arranged, two adjacent action modules M1 may be spaced from each other. Even so, the plurality of action modules M1 may also detect their arrangement order by communicating with each other by any appropriate means such as near field communication (NFC) or optical communication. Still alternatively, the arrangement order of the plurality of action modules M1 may also be detected based on, for example, the output of a camera that captures an overall image of the plurality of action modules M1.

Furthermore, in the first embodiment described above, the plurality of action modules M1 are colored in mutually different colors. However, this configuration is only an example and should not be construed as limiting. Alternatively, the plurality of action modules M1 may have the same color. Still alternatively, the plurality of action modules M1 may also be colored in multiple colors that vary according to the category of their associated action.

Furthermore, in the first embodiment described above, the action modules M1 are supposed to be block toys such as respective pieces of puzzle blocks. However, this configuration is only an example and should not be construed as limiting. Alternatively, a stuffed action module M1, which is a stuffed toy with the circuit block 11 and other components built in, may also be adopted. In this case, an action module M1 of the type that is likely to attract the target person's X1 attention is suitably used adaptively to the individual target person X1. Therefore, if the target person X1 is a kid, the action module M1 suitably simulates a toy that is likely to attract the kid's attention. Specifically, if the target person X1 is a boy, an action module M1 with a shape simulating a vehicle or conveyance may be adopted. On the other hand, if the target person X1 is a girl, then an action module M1 with a shape simulating a stuffed animal may be adopted, for example.

Furthermore, the operating unit 12 does not have to be a momentary push-button switch. Alternatively, the operating unit 12 may also be configured as a touch switch, a voice switch, or a gesture switch (also called a “gesture sensor”), for example.

Furthermore, in the embodiment described above, each action module M1 is supposed to be fixable on a wall surface of the facility F1 with an appropriate means such as a magnet or a sucking disc. However, this is not an essential configuration. Alternatively, each action module M1 may also be used to be put on a floor or a table, instead of being fixed on a wall surface.

Furthermore, in the embodiment described above, the plurality of action modules M1 are arranged to generate and set the schedule D1. However, this is only an example and should not be construed as limiting. Alternatively, the target person X1 may set the schedule D1 together with the manager X2, for example. Still alternatively, a person other than the target person X1 (e.g., the manager X2) may set the schedule D1 instead.

### Second Embodiment

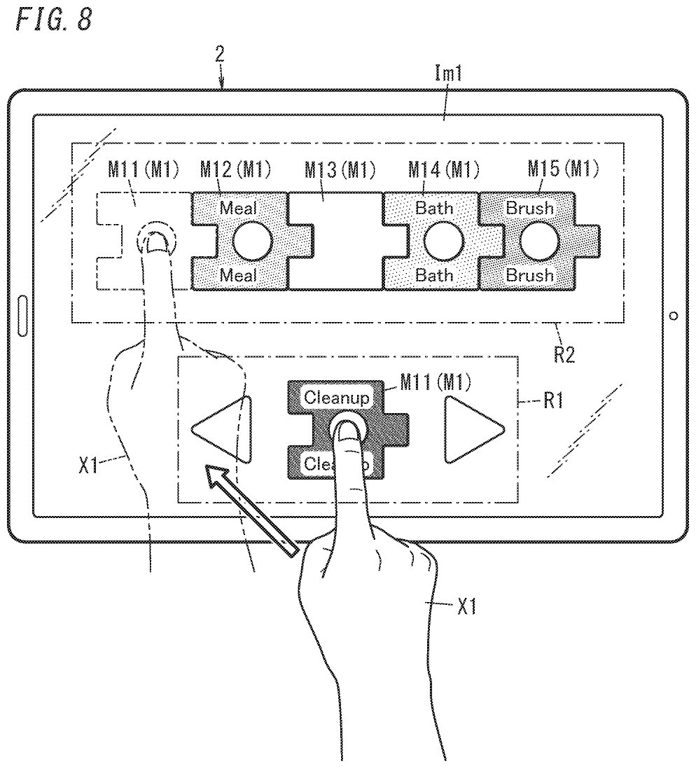

In an action management method according to a second embodiment, the action modules M1 are intangible objects as shown in FIG. 8, which is a major difference from the action management method according to the first embodiment. In the following description, any constituent element of this second embodiment, having the same function as a counterpart of the first embodiment described above, will be designated by the same reference numeral as that counterpart's, and description thereof will be omitted as appropriate herein.

The action management method according to this embodiment is used on a graphical user interface (GUI) of a computer system. That is to say, the action management method includes a method for displaying a setting screen image Im1 on a telecommunications device 2, of which a major constituent element is a computer system. Furthermore, in the telecommunications device 2, one or more processors accept a person's operating command entered through the setting screen image Im1 on the graphical user interface. In this example, the setting screen image Im1 is supposed to be displayed on the telecommunications device 2 implemented as a tablet computer. This telecommunications device 2 includes a touchscreen display and determines that an object such as a button has been manipulated (such as tapped, swiped, or dragged) by detecting the manipulation of the object on each screen image displayed on the display unit. As used herein, the “screen image” refers to an image (such as a text, graph, or an icon) produced on the display unit of the telecommunications device 2.

In this embodiment, the plurality of action modules M1 which are intangible objects, are virtually arranged within the setting screen image Im1, thereby generating a schedule D1 in accordance with the arrangement order of the plurality of action modules M1. That is to say, in the first embodiment described above, the schedule D1 is generated by actually arranging the plurality of action modules M1 which are tangible objects. In contrast, in this embodiment, the schedule D1 is generated simply by operating the telecommunications device 2.

Next, the generation processing of generating the schedule D1 in the action management method according to this embodiment will be described with reference to FIG. 8. FIG. 8 illustrates a specific example of a setting screen image Im1 to be displayed on the telecommunications device 2. Note that the one-dot chains indicating the boundaries and the reference signs are shown there just for the sake of convenience of description. That is to say, the one-dot chains and the reference signs are not actually displayed on the telecommunications device 2.

The setting screen image Im1 includes a selection region R1 and an assembly region R2. First, the target person X1 selects an action module M1 within the selection region R1 in a lower part of the setting screen image Im1. In the selection region R1, one action module M1 and cursors are displayed. The target person X1 may switch the action modules M1 by operating the cursors. In the example illustrated in FIG. 8, the action module M11 associated with “clean up” is selected in the selection region R1.

The target person X1 drags the action module M11, which has been selected in the selection region R1, to the assembly region R2. In FIG. 8, a finger of the target person X1 and the action module M11 after dragging are indicated in phantom (by the two-dot chains). In this example, the target person X1 drags the action module M11 to beside the left end of the plurality of action modules M12-M15 displayed on the assembly region R2. As a result, the five action modules M11-M15 are arranged in the order of M11, M12, M13, M14, and M15 from left to right in the assembly region R2. Thus, the generation processing includes generating the schedule D1 in accordance with the arrangement order of the five action modules M11-M15.

Note that various constituent elements or features described for this second embodiment may be adopted as appropriate in combination with the various constituent elements or features described for the first embodiment (including its variations).

(Recapitulation)

As can be seen from the foregoing description, an action management method according to a first aspect includes generation processing and acquisition processing. The generation processing includes generating a schedule (D1) in accordance with an arrangement order of a plurality of action modules (M1). The plurality of action modules (M1) represent respective actions to be performed by a target person (X1). The schedule (D1) indicates an order in which the target person (X1) is supposed to perform the actions. The acquisition processing includes acquiring an action log (D2) indicating an execution status in which the target person (X1) is following the schedule (D1).

According to this aspect, a schedule (D1) is generated through the generation processing in accordance with an arrangement order of a plurality of action modules (M1) representing respective actions to be performed by a target person (X1). Therefore, even if the target person (X1) is going to set his or her own schedule (D1) by him- or herself, for example, the target person (X1) may generate the schedule (D1) relatively easily simply by rearranging the plurality of action modules (M1). In addition, according to this aspect, information about the execution status in which the target person (X1) is following the schedule (D1) may be acquired in the form of an action log (D2). Therefore, this action management method achieves the advantage of allowing the degree of faithfulness, with which the target person (X1) has actually performed the actions following the schedule (D1), to be evaluated easily based on the action log (D2).

An action management method according to a second aspect, which may be implemented in conjunction with the first aspect, further includes acceptance processing. The acceptance processing includes accepting, from the target person (X1), an operating command indicating at least one of a beginning or an end of any one of the actions.

According to this aspect, letting the target person (X1) enter an operating command indicating at least one of a beginning or an end of an action increases the target person's (X1) consciousness of the schedule (D1), which eventually leads to forming a good habit of following the schedule (D1).

In an action management method according to a third aspect, which may be implemented in conjunction with the first or second aspect, the action log (D2) includes timing information (D21) about at least one timing selected from the group consisting of a timing indicating a beginning of any one of the actions and a timing indicating an end of the action.

According to this aspect, the timing information (D21) tells the user at least one of a timing indicating the beginning of the action or a timing indicating the end of the action, thus allowing the user to make detailed evaluation of the target person's (X1) actions.

In an action management method according to a fourth aspect, which may be implemented in conjunction with any one of the first to third aspects, the schedule (D1) includes order information indicating the order in which the actions are required to be performed but does not include time information indicating at least one of a start time of any one of the actions or an end time of the action.

According to this aspect, only the order in which the actions are required to be performed is specified with respect to the target person (X1), thus making it relatively easy to set the schedule (D1). In addition, this also reduces the chances of the schedule (D1) binding the target person's (X1) actions excessively.

In an action management method according to a fifth aspect, which may be implemented in conjunction with any one of the first to fourth aspects, each of the plurality of action modules (M1) is a tangible object. The arrangement order of the plurality of action modules (M1) is determined by physically combining the plurality of action modules (M1) with each other.

This aspect makes it easier for the target person (X1) to handle the plurality of action modules (M1).

An action management method according to a sixth aspect, which may be implemented in conjunction with any one of the first to fifth aspects, further includes guidance processing. The guidance processing includes presenting, to the target person (X1), guidance information about the actions to be performed following the schedule (D1).

According to this aspect, presenting the guidance information facilitates attracting the target person's (X1) attention to the actions defined by the schedule (D1), which eventually leads to forming a good habit of following the schedule (D1).

In an action management method according to a seventh aspect, which may be implemented in conjunction with the sixth aspect, the guidance processing includes changing, according to the execution status in which the target person (X1) is performing the actions, a mode of presentation of the guidance information.

According to this aspect, presenting the guidance information further facilitates attracting the target person's (X1) attention to the actions defined by the schedule (D1).

In an action management method according to an eighth aspect, which may be implemented in conjunction with any one of the first to seventh aspects, the generation processing includes generating the schedule (D1) in accordance with an arrangement order of the plurality of action modules (M1) which are coupled together to be arranged in line.

According to this aspect, the plurality of action modules (M1) are coupled together, thus allowing the plurality of action modules (M1) to be handled as a single structural body and thereby making it easier to handle the plurality of action modules (M1).

In an action management method according to a ninth aspect, which may be implemented in conjunction with any one of the first to eighth aspects, the action log (D2) includes target person information about a status of the target person (X1) who is performing any one of the actions.

According to this aspect, the action log (D2) provides the user with not only information about the execution status in which the target person (X1) is following the schedule (D1) but also the status of the target person (X1) who is performing any one of the actions.

An action management method according to a tenth aspect, which may be implemented in conjunction with any one of the first to ninth aspects, further includes arithmetic processing. The arithmetic processing includes generating, based on the action log (D2), arithmetic information by performing arithmetic operations on the action log (D2).

According to this aspect, using the arithmetic information allows the user to evaluate, for example, the degree of improvement in the execution status in which the target person (X1) is following the schedule (D1).

In an action management method according to an eleventh aspect, which may be implemented in conjunction with the tenth aspect, the target person (X1) includes a plurality of target persons. The arithmetic information includes statistical information generated based on at least the action log (D2) with respect to each of the plurality of target persons (X1).

According to this aspect, the statistical information provides the user with statistics on the statuses of the plurality of target persons (X1), thus allowing the user to evaluate, for example, the degrees of improvement in the execution statuses in which the target persons (X1) are following their schedules (D1).

In an action management method according to a twelfth aspect, which may be implemented in conjunction with the eleventh aspect, the statistical information includes comparison information indicating evaluation of a particular target person (X1) relative to the plurality of target persons (X1).

This aspect facilitates, when a particular target person (X1) is compared with other target persons (X1), for example, the user evaluating, based on the comparison information, the degree of improvement in the execution status in which the particular target person (X1) is following the schedule (D1).

An action management method according to a thirteenth aspect, which may be implemented in conjunction with any one of the tenth to twelfth aspects, further includes output processing including providing a particular terminal with output information. The output information includes the action log (D2) and the arithmetic information at least partially.

This aspect allows the particular terminal to use the action log (D2) and the arithmetic information at least partially.

An action management method according to a fourteenth aspect, which may be implemented in conjunction with any one of the first to thirteenth aspects, further includes setting processing. The setting processing includes setting a goal about the actions in association with the action modules (M1).

According to this aspect, setting a goal allows the target person (X1) to be motivated toward his or her action to perform.

In an action management method according to a fifteenth aspect, which may be implemented in conjunction with any one of the first to fourteenth aspects, the target person (X1) includes a plurality of target persons. The method further includes list displaying processing. The list displaying processing includes displaying, as a list, information based on a plurality of action logs (D2) acquired, through the acquisition processing, with respect to the plurality of target persons (X1).

This aspect facilitates the user collecting information about correlation between the plurality of target persons (X1) in terms of their respective schedules (D1) and the execution statuses in which the target persons (X1) are following their schedules (D1).

A program according to a sixteenth aspect is designed to cause one or more processors to perform the action management method according to any one of the first to fifteenth aspects.

This aspect achieves the advantage of allowing the degree of faithfulness, with which the target person (X1) has actually performed the actions following the schedule (D1), to be evaluated easily based on the action log (D2).

An action management system (1) according to a seventeenth aspect includes a generation unit (111) and an acquisition unit (112). The generation unit (111) generates a schedule (D1) indicating an order in which a target person (X1) is required to perform actions. The acquisition unit (112) acquires an action log (D2) indicating an execution status in which the target person (X1) is following the schedule (D1). The generation unit (111) generates the schedule (D1) in accordance with an arrangement order of a plurality of action modules (M1) representing the respective actions to be performed by the target person (X1).

This aspect achieves the advantage of allowing the degree of faithfulness, with which the target person (X1) has actually performed the actions following the schedule (D1), to be evaluated easily based on the action log (D2).

Note that these are not only aspects of the present disclosure but various configurations of the action management method according to the first and second embodiments (including their variations) may also be implemented as a program or an action management system (1).

It should also be noted that constituent features according to the second to fifteenth aspects are not essential constituent features for the action management method but may be omitted as appropriate.

### REFERENCE SIGNS LIST

1 Action Management System
111 Generation Unit
112 Acquisition Unit
D1 Schedule
D2 Action Log
M1, M1-M15 Action Module
X1 Target Person

1. An action management method comprising:
generation processing including generating a schedule indicating an order in which a target person is required to perform actions in accordance with an arrangement order of a plurality of action modules, the plurality of action modules representing the respective actions to be performed by the target person; and
acquisition processing including acquiring an action log indicating an execution status in which the target person is following the schedule.

2. The action management method of claim 1, further comprising acceptance processing including accepting, from the target person, an operating command indicating at least one of a beginning or an end of any one of the actions.

3. The action management method of claim 1, wherein
the action log includes timing information about at least one timing selected from the group consisting of a timing indicating a beginning of any one of the actions and a timing indicating an end of the action.

4. The action management method of claim 1, wherein
the schedule includes order information indicating the order in which the actions are required to be performed but does not include time information indicating at least one of a start time of any one of the actions or an end time of the action.

5. The action management method of claim 1, wherein
each of the plurality of action modules is a tangible object, and
the arrangement order of the plurality of action modules is determined by physically combining the plurality of action modules with each other.

6. The action management method of claim 1, further comprising guidance processing including presenting, to the target person, guidance information about the actions to be performed following the schedule.

7. The action management method of claim 6, wherein
the guidance processing includes changing, according to the execution status in which the target person is performing the actions, a mode of presentation of the guidance information.

8. The action management method of claim 1, wherein
the generation processing includes generating the schedule in accordance with an arrangement order of the plurality of action modules which are coupled together to be arranged in line.

9. The action management method of claim 1, wherein
the action log includes target person information about a status of the target person who is performing any one of the actions.

10. The action management method of claim 1, further comprising arithmetic processing including generating, based on the action log, arithmetic information by performing arithmetic operations on the action log.

11. The action management method of claim 10, wherein
the target person includes a plurality of target persons, and
the arithmetic information includes statistical information generated based on at least the action log with respect to each of the plurality of target persons.

12. The action management method of claim 11, wherein
the statistical information includes comparison information indicating evaluation of a particular target person relative to the plurality of target persons.

13. The action management method of claim 10, further comprising output processing including providing a particular terminal with output information, the output information including the action log and the arithmetic information at least partially.

14. The action management method of claim 1, further comprising setting processing including setting a goal about the actions in association with the action modules.

15. The action management method of claim 1, wherein
the target person includes a plurality of target persons, and
the method further comprises list displaying processing including displaying, as a list, information based on the plurality of action logs acquired, through the acquisition processing, with respect to the plurality of target persons.

16. A non-transitory computer-readable tangible recording medium storing a program designed to cause one or more processors to perform the action management method of claim 1.

17. An action management system comprising:
a generation unit configured to generate a schedule indicating an order in which a target person is required to perform actions; and
an acquisition unit configured to acquire an action log indicating an execution status in which the target person is following the schedule,
the generation unit being configured to generate the schedule in accordance with an arrangement order of a plurality of action modules, the plurality of action modules representing the respective actions to be performed by the target person.
